(19) United States
(12) Patent Application Publication
(10) Pub. No.: US 2009/0077079 A1
(43) Pub. Date: Mar. 19, 2009

(54) METHOD FOR CLASSIFYING INTERACTING ENTITIES

(75) Inventors: Achim RETTINGER, Munich (DE); Volker Tresp, Munich (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 12/115,244

(22) Filed: May 5, 2008

(30) Foreign Application Priority Data
Sep. 18, 2007 (EP) 07018309

(51) Int. Cl. G06F 7/00

(52) U.S. Cl. 707/7

(57) ABSTRACT

Interacting entities are classified into cluster classes, where an interaction is a relation between two entities based on a promised outcome by each entity and an effective outcome of the interaction. A model for infinite relational trust is used which has hidden variables associated with entity classes corresponding to the entities. A conditional probability distribution of the hidden variables is calculated depending on observable attributes assigned to the entities and the relations.

### CROSS REFERENCE TO RELATED APPLICATIONS

This application is based on and hereby claims priority to European Application No. 07018309 filed on Sep. 18, 2007, the contents of which are hereby incorporated by reference.

### BACKGROUND

This disclosure relates to a method for classifying interacting entities, for example, into cluster classes.

For instance, in many modern open and distributed software systems such as web services, e-commerce, trust computing, Grid computing or Peer-to-Peer networks, autonomous entities have to cooperate. However, often the interests, intentions, goals or capabilities of the cooperating units or entities cannot be determined reliably. It is for example desirable to predict the trustworthiness of single entities or units, for example, from previous actions. Conventionally, each cooperating unit or entity is assigned a trust value being a measure for interacting reliably with other entities. For example, in the internet auction community eBay each user is assigned a score value indicating to other users whether the user has acted properly in previous actions (interactions). In this example, the set score value is based on ratings of preceding interactions of the entity or users with others in the community.

However, it would be also desirable to provide a measure for initial trust without relying on extensive past experiences. For example, psychological studies indicate that people can robustly draw trait inferences, like a trustworthiness, from the mere facial appearance of unknown people within an extremely short time period. For example, in economic or financial transactions sometimes no well defined past experience for the corresponding trustee is available. To make such initial trust computationally and systematically feasible one has to consider more than a specific context as the trait situation but also attributes assigned to the interacting entities or the type of interactions can be involved.

Some of the above-mentioned problems are addressed by the method described below.

### SUMMARY

This disclosure presents a method for classifying interacting entities into cluster classes. An interaction may be a relation between two entities based on a promised outcome by each entity and an effective outcome of the interaction. The method uses a model for trust having infinite relational hidden variables. The hidden variables are associated with entity classes corresponding to the entities and may in particular correspond to cluster assignments of the entities into the cluster classes. A conditional probability distribution of the hidden variables is calculated depending on observable attributes assigned to the entities and the relations.

An entity may be an interacting agent or an external condition. Incorporating hidden variables for the cluster assignments, in principle, allows an arbitrary number of cluster classes. According to one aspect of the method attributes are assigned to external conditions and interacting agents. Such attributes may be considered when calculating the conditional probability of a classification of an agent or condition into cluster groups. As a result, the classifications may be employed for finding an appropriate strategy for offering a promised outcome of agents interacting in a cooperating system including the interacting agents or entities.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a DAPER diagram of an infinite relational trust model, which may be exemplarily employed in a variation of the method for classifying interacting entities.

FIGS. 2.1, 2.2, 2.3A and 2.3B are line graphs of results from classification examples employing the method illustrated in FIG. 1.

FIG. 3 is a bar graph of an example of clustering in an exemplary model of four different agent types wherein interaction is modelled by trades.

FIG. 4 is a line graph of the performance of a classification method according to an aspect of the method illustrated in FIG. 1, in comparison to known classification models.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

This disclosure presents methods for classifying interaction entities into classes. This may be regarded as assigning initial trust values to such interacting entities without having any prior experiences with the trustee or the trustor. For example, attributes of a person one needs to trust are included as well as of external circumstances in which the trust decision is made. Further, actions and promises the person as an entity has given to seek others confidence is taken into consideration. According to one aspect of the method for classifying interacting entities several trust related measures are considered which is contrary to known classification models or methods where usually only a single trust value is assigned to an agent or entity.

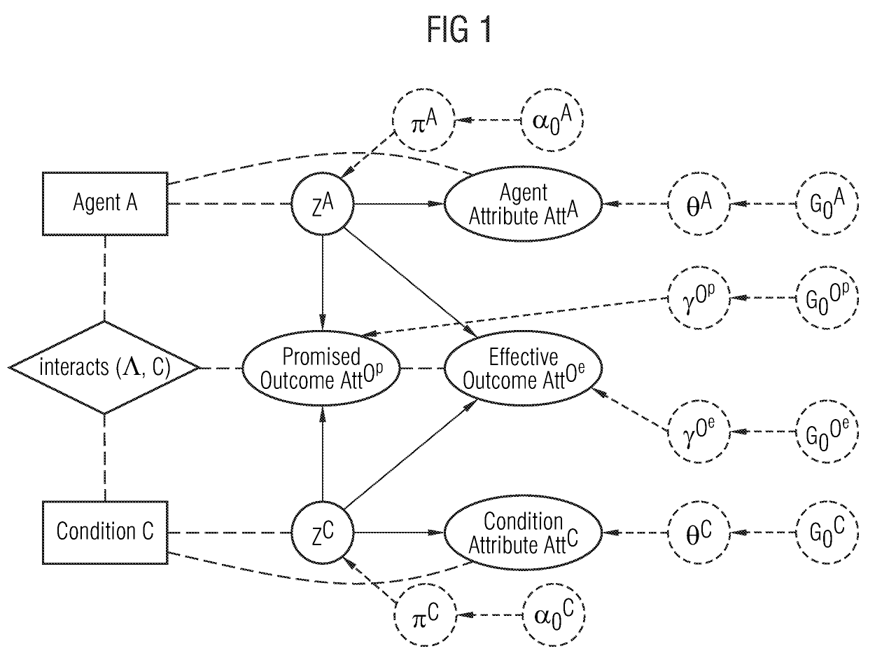

As a model that may be employed when classifying interacting entities an infinite relational trust model as shown in FIG. 1 in a DAPER diagram is considered. Generally, for implementing the method entities and social interactions between those entities are considered. As an example one agent as an entity needs to trust (trustor) in something or someone (trustee). Hence, the underlying system of interacting entities includes:

a set of agents A (trustees) that are willing to interact with the trustor, wherein each agent is wherein a set of observable attributes Att^{A}. For example, an agent may be considered as a person or any instance that may be trusted, like a company, a brand, or an authority. For example, when ordering goods from a selection of suppliers a requestor is a trustor and the suppliers act as trustee agents.

further, a set of external conditions C with corresponding attributes Att^{C} is considered. A condition could be the type of service provided by the trustee, for example a specific merchandise or good. The external condition C employs external facts relating to a particular in a situation in which an interaction between the trustor and trustee occurs. This can be, for example, the trustor's or requestor's financial resources or a current market value of the goods in question.

an interaction can be regarded as a relation interacts(A, C). The relation has assigned a set of relationship attributes Att^{O} that capture negotiable interaction issues depending on a specific agent aεA and specific conditions cεC. The interacting agents, in general, can directly manipulate those attributes relating to the interaction.

In FIG. 1 entity classes A and C are shown as rectangles wherein the in between relationship class interacts(A, C) is shown as a rhombus. This visualization of the relational internal dependencies between the entities is known as DAPER model.

Attributes connecting to the relation interacts(A, C) may be separated into two sets. The promised outcome O^{P} includes attributes Att^{OP} that are generally observable before the trust-act, i.e. before the interaction is concluded. For example, an attribute of this category can be the price of a merchandize or the scope of the services on offer. A promised outcome o^{P} εO^{P} is an assignment of values to the corresponding attribute vector Att^{OP}. This attribute vector can be negotiated by die trustor and trustee. In the negotiating phase of the interaction for, example both, agents, for example the buyer and the seller, agree on a particular price and amount of merchandize.

In addition, the effective outcome O^{e} is connected to the relation interacts(A, C). Those attributes Att^{Oe} are not observable until the trust-act has been carried out. The attributes Att^{Oe} may be regarded as a feedback or judgment for the trustee in respect to its expectations. Att^{Oe} corresponds, for example, to the objectives or interests of the trustor and should be optimized as in a multi-criteria optimization problem.

In classifying the entities or, for example, agents in an interaction trust scenario conclusions can be drawn with respect to an optimized negotiation strategy. For example, it is desirable to obtain a value function o^{P}→o^{e} that may allow to predict o^{e} from a given o^{P} that is proposed by an agent a under external conditions c. One can also define a utility function o^{p}→[0, 1] that corresponds to a utility measure. If this function is known a trustor may adapt a strategy in its negotiation and assign a particular O^{P} as a promised outcome.

The relational trust model as shown in FIG. 1 provides for hidden variables Z^{A}, Z^{C} that correspond to the classification of entities or agents into respective classes or groups. The hidden variables Z^{A}, Z^{C} connected through the dashed lines to the entity classes A, C provide for clustering of the entities into clusters. Clusters may include certain agent types but also condition types. In principle, an infinite number of clusters may arise through those hidden variables. It is assumed for simplicity that every entity class has a hidden variable Z^{A} and Z^{C} having a number of r^{a} and r^{c} clusters, respectively.

The cluster assignment or the classifying of the entities into cluster classes is inferred from the conditional distribution

P(ZA,ZC|AttA,AttC,AttO)

of cluster assignments Z given evidence about attributes Att (including relationship attributes). This posterior distribution can be formed from the generative model by

P(Z,Att)=ΠP(Att|Z)ΠP(Z)

The prior on cluster assignments π^{A} and π^{C} is given as a Dirichlet distribution with hyperparameters α, where sampling can be induced by a Chinese Restaurant Process: Z|α₀˜CRP(α₀). By the use of the Chinese Restaurant Process the number of clusters can be determined in an unsupervised fashion. Entities are assigned to (potentially new) clusters corresponding to the size of the existing clusters. Entity attributes Att^{A}, and Att^{C} are samples from multinominal distributions with parameters θ^{A}, θ^{C} G₀=Dir (·|β) and are generated for each cluster in Z^{A} and Z^{C}. The same applies for the relationship attributes Att^{O} which can be induced by a multinomial distribution with parameters γ˜G₀. However, γ needs to be generated for every combination of entity attribute clusters, resulting in r^{a}×r^{c} parameter vectors.

Now, inference can be carried out based on Gibbs sampling by estimating P(Z|Att)∝P(Att|Z)P(Z). For instance, the probability of agent i being assigned to cluster k^{A} is proportional to

$$P ( {Z}^{A} = {k}^{A} \vert {Z}^{A} , {Z}^{C} , {¸}^{A} , {<}^{{O}^{P}} , {<}^{{O}^{e}} ) ∝ {N}_{{k}^{A}} P ( {Att}_{i}^{A} \vert {¸}_{{k}^{A}}^{A} , {<}_{{k}^{A} , *}^{{O}^{P}} , {<}_{{k}^{A} , *}^{{O}^{e}} )$$

Where Nₖ_{^{A}} is the number of agents already assigned to cluster k^{A}. Finally, standard statistical

$${<}_{{k}^{A} , {k}^{C}}^{{O}^{e}}$$

parameter estimation techniques can be used for estimating from given cluster assignments.

The parameters α₀ and β affect the number of clusters and the certainty of priors and can be tuned. However, simulation results remain robust without extensive tuning. In the following exemplary implementation α₀=10 and β=20 are fixed.

As a consequence, an underlying algorithm to implement the method enables to handle more than one relationship attribute. Therefore, a corresponding representation of the interaction context enables multidimensional trust values.

It is assumed, for example, that each entity belongs to exactly one cluster. Then, one may predict the value of the attributes Att^{OP} from the result and conditional distribution P(Z^{A}, Z^{C}|Att^{A}, Att^{C}, Att^{O}). Thereby, the interacting entities are classified into clusters. By employing the above mentioned sampling and interference method according to the above elaborated algorithm clusters and the relationships between clusters are discovered while irrelevant attributes are ignored.

It is an advantage that although the value of attributes is determined entirely by the clusters assignment of associated entities there is no need for direct dependencies among attributes or a need for structural learning within the model. The hidden variables may be regarded as “hubs” while information propagates through the network of interrelated entities. Also the number of clusters is not fixed in advance. Thereby, the optimum number of clusters is discovered automatically through the sampling and inference process.

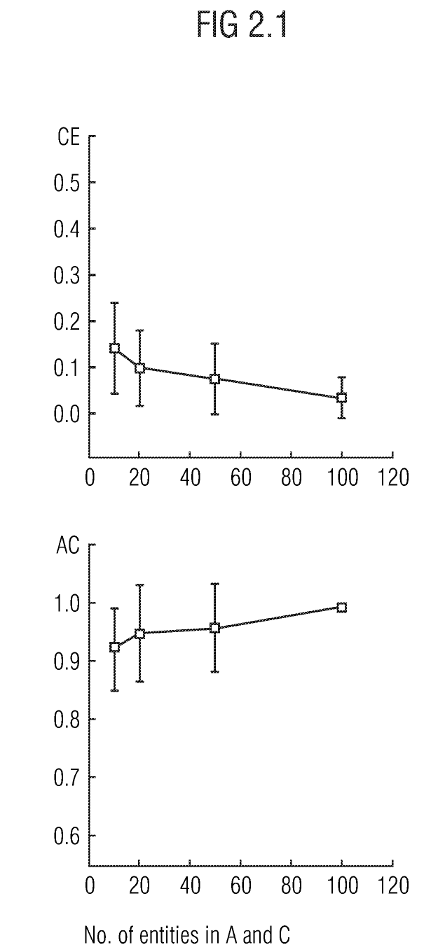

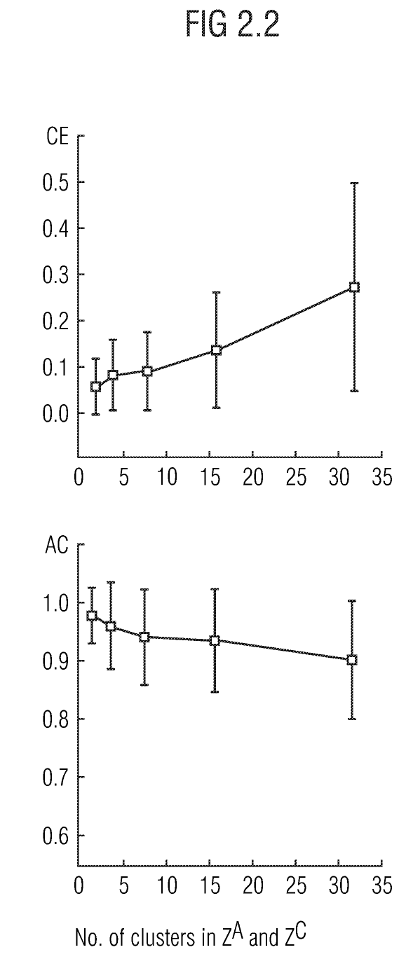

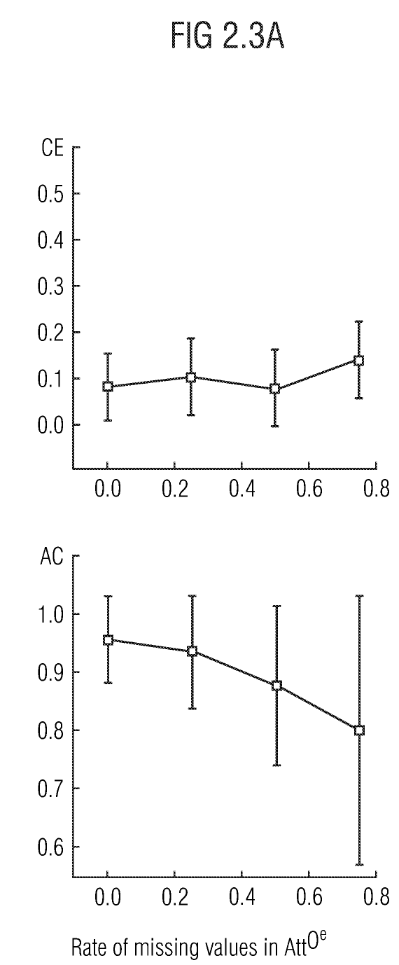

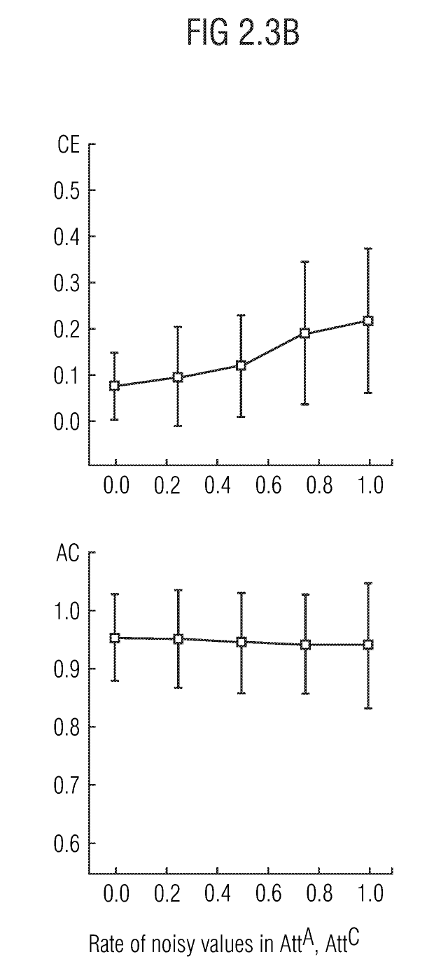

FIG. 2 shows results from a classification method as described herein. Cluster assignments are performed in dependence of the conditional distribution for Z above. Applicants generated synthetic data and performed the above-specified method to find clusters in this data. As a model an interaction trust scenario with a fixed number of two entity attributes and two relationship attributes one for O^{P} and one for O^{e} are assumed. Four different runs of the method implemented as an algorithm in terms of a computer program a number of entities |A| and |C| are predetermined for each run. Also the cluster size r^{a} and r^{c} for Z^{A} and Z^{C} are fixed. Then, each entity is randomly assigned to a cluster and its attributes are sampled from a multinominal distribution with four possible outcomes and a parameter vector θ each. For each cluster θ randomly generated. Further, r^{a}×r^{c} and Bernoulli parameters γ for the relationship attribute att^{o}^{^{P}} and att^{o}^{^{e}} are constructed.

In FIG. 2 the performance of the method for classifying the interacting entities in terms of the infinite relational trust model (IRTM) is illustrated. The top row curves show a classification error metric (CE) for cluster assignments and the bottom row shows the accuracy (AC) for classifying att^{o}^{^{e}} correctly. The vertical lines indicate a 95% confidence interval. CE corresponds to the difference of the estimated cluster label and the underlying cluster label. A value of 0 relates to an exact match and a value of 1 to a maximum difference.

In FIG. 2.1 for cluster sizes size r^{a}=r^{c}=4 the performance increases for an increasing number of entities. However, already for a number of entities |A|=|C|>20 a remarkable classification is achieved.

In FIG. 2.2 curves corresponding to a set-up where the number of entities is |A|=|C|=50 and different cluster sizes r^{a} and r^{c} are recovered. The x-axis refers to the number of clusters, and it can be seen that for cluster sizes lager than 16 the classification error metric increases, however still the AC remains above 90%.

FIGS. 2.3a and 2.3.b show the performance of the classification method for noisy data. The curve shown in FIG. 2.3a refers to a situation where evidence for O^{e} is partially omitted, i.e. the effective outcome that is to be predicted is not available. Still, cluster assignment works well. In FIG. 2.3.b noise, i.e. random values are added to Att^{A} and Att^{C}. It can be seen from FIG. 2.3.b that noisy information in the attributes does not severely affect the performance of the method for cluster assignment.

In summary, FIG. 2 shows that the before-mentioned method based on cluster assignments through hidden variables and their conditional probability wherein a prior on cluster assignment depends on sampling according to a Chinese Restaurant Process leads to reliable clustering results.

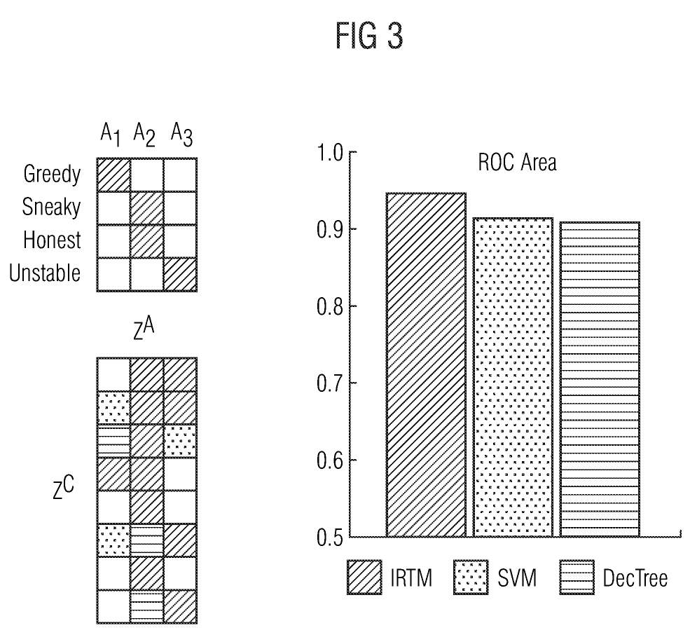

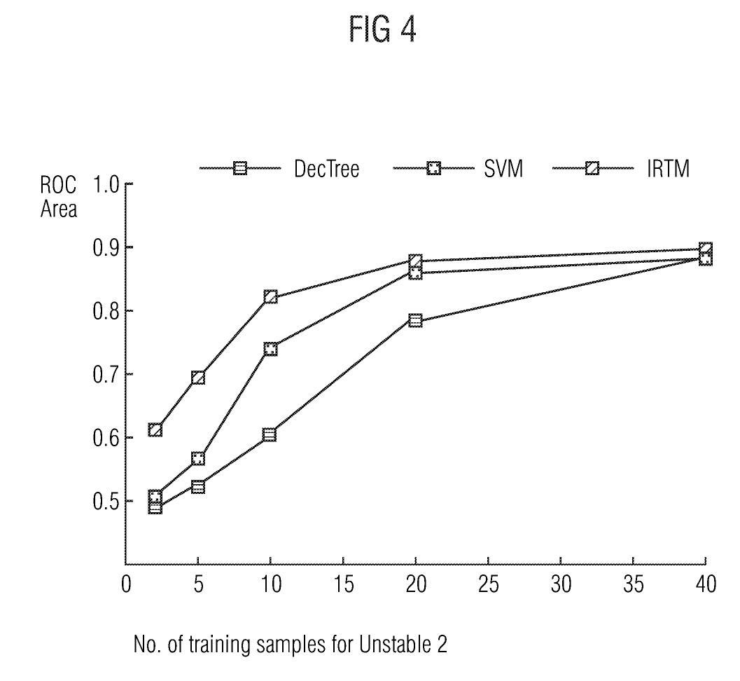

The following FIGS. 3 and 4 show results for another example of an application of the method for classifying interacting agents or entities. Often finding an agreement between participants or agents of conflicting interests is necessary in a system. This holds for example for auctions, preference aggregations, game theory or automated negotiations.

As an example, it may be desirable to evaluate trust into new customers or unknown suppliers. It may be also desirable in a sensor network to predict the reliability of sensor data if the actual data provider is unknown and no previous experience can be used. In particular, in open systems where agents can enter and leave the system or change their identity, as it is for example the case in Peer-to-Peer Networks, an initial trust may play a role. If in terms of an IRTM predictions on Att^{Oe} can be made the strategies of the participating agents may be improved.

Next, a multi agent negotiation framework having an additional trading step is considered. For example, an interaction relation according to this example has three phases:

1. Negotiation: A mechanism or strategy of agents that calculates a possible outcome O^{P} both parties can agree on (e.g., an exchange of goods).
2. Trading: The decision made by every agent whether to stick to a bargain or break it (possibly only partially). The outcomes regarding the agent's obligations are executed according to the agent's decision.
3. Evaluation: The agents can review the effective actions Att^{O}^{^{e}} of the opponent by observing the received goods and draw conclusions for future interactions.

This procedure is repeated over a specified number of rounds with different types of agents.

As an example, four different agent types are assumed as opponents in a negotiation process. Every round in the negotiation the promised outcome O^{P} and the effective outcome O^{e} is recorded. For the sake of simplicity, all agent types have a static negotiation strategy. However, they are distinct by their trading phase strategy. A first type of agent Greedy always maximizes its utility regardless of O^{P}. A second type, a Sneaky-agent deviates from O^{P} if it increases its utility by a large margin. A third type, the Honest-agent, sticks to O^{P} always. A fourth agent named Unstable deviates only slightly from O^{P} by giving away +/−1 amount if its utility is increased thereby.

On can imagine this negotiation framework or system of interacting agents as a market place where agents act as buyers and sellers and either stick to their promised prize and/or service or don't. The relevant negotiation outcome can be modeled as attributes of C instead of O^{P} because the negotiation strategies are the same for all agent types.

Att^{O}^{^{e}} corresponds to the binary classification task whether the utility increases less than the negotiated one or not. In this exemplary constellation ca. 120 interactions are carried out per agent type leading to a total of 165 different negotiation outcomes. FIG. 3 shows the predictive performance of the IRTM classification method in comparison to known approaches, i.e. a support vector machine (SVM) using a PolyKernel and a Decision Tree (DecTree, ID3). For the SVM and DecTree additional inputs in terms of a unique ID number for each agent in this way are necessary.

The columns on the right hand diagram in FIG. 3 show the accuracy for classifying P(O^{e}). This is done by calculating the area under the corresponding ROC curve. ROC refers to receiver operating characteristic, and ROC analysis provides tools for evaluating a classification model or method. In comparison to known models or methods for classifying interacting agents the method according to this disclosure shows the best performance.

The top left figure in FIG. 3 shows that the four different types of agents are classified into a total of three different clusters A₁, A₂ and A₃. The four agent types (rows) are clustered into three groups in Z^{A} (columns). It can be seen that the Sneaky and Honest agents are classified to the same cluster. This suggests for a strategy that acting reliable and providing confidence most of the time in order to convince an opponent of its own trustworthiness may be preferable. However, if the gain in utility is extraordinary it may be worth to betray the opponent's trust. Hence, from the classification into clusters of the agents an optimized strategy for the negotiation can be deducted.

In the lower left corner of FIG. 3 the conditional probability P(O^{e}|Z^{A}, Z^{C}) is illustrated. Brighter rectangles indicate a lower probability for utility increase as negotiated. The 165 different negotiation outcomes and external conditions lead to 8 clusters for Z^{C}. Hence, the graph illustrates each row as a condition-cluster, i.e. Zᵢ^{C}, and at each column an agent cluster Zᵢ^{A}. It can be seen from this figure that the Greedy-agent cluster shows brighter values than the third column for the Unstable-agent cluster. However, the cluster having Sneaky and Honest-agents overall shows the best utility increase in average over the conditions.

Based on the same assumptions as above the ROC area, i.e. the accuracy, for the Unstable-agent is shown in FIG. 4. The AUC is plotted for different numbers of training samples. It can be seen that especially for a few training samples the performance of the IRTM model exceeds the performance of known classification models.

Hence, the inherent cluster in terms of the IRTM is useful in classifying interacting entities in particularly for an initial trust situation when unknown but related agents and conditions are observed. The method allows assigning entities to clusters correctly without having access to single effective outcomes. Rather, through considering the attributes a reliable clustering is feasible.

The presented methods allow predicting or inferring the trustworthiness of entities in previously not experienced situations. Context can be considered and thereby complex interdependencies relating to trust are considered. Since initial trust situations and scenarios are explicitly relational, for example, for social interactions the method employing an IRTM is in particular suited.

Apart from the negotiation framework shown in one of the examples the method may also be employed in a variety of further situations. For example, a car manufacturer may classify the relevant suppliers according to such a method, considering, for example, the reliability, delivery time, prizes and so forth. Also the reliability or trustworthiness of sensor data provided by different services providers may be subject of the classification according to one of the presented aspects method. This may be applicable, for example, for surveillance applications.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A method for classifying interacting entities into cluster classes, an interaction being a relation between two entities based on a promised outcome by each entity and an effective outcome of the interaction, comprising:
defining a model for trust in which infinite relational hidden variables are associated with entity classes corresponding to the entities, the hidden variables corresponding to cluster assignments of the entities into the cluster classes; and
calculating a conditional probability distribution of the hidden variables depending on observable attributes assigned to the entities and the relation.

2. The method of claim 1, wherein an entity is an interacting agent having agent attributes or an external condition having condition attributes.

3. The method of claim 2, wherein the agent attributes include at least one of a person, a brand and a company.

4. The method of claim 2, wherein the condition attributes include at least one of a service, merchandize, a market value of merchandize, and an accessibility of goods.

5. The method of claim 1, wherein the relation has a relationship attribute of a relationship attribute class, the relationship attribute class comprising promised outcome attributes and effective outcome attributes.

6. The method of claim 5, wherein the promised outcome attributes include at least one of a price of a merchandize, a quality, a delivery time, and a negotiation time period.

7. The method of claim 5, wherein the effective outcome attributes include at least one of a measure of satisfaction with a completion of an interaction, and a deviation from the promised outcome.

8. The method of claim 1, wherein the number of the cluster assignments of the entities into the cluster classes is determined by a Chinese Restaurant Process.

9. The method of claim 1, wherein the interaction between two entities comprises a negotiating phase in which the entities agree on a promised outcome of the interaction, a proposed outcome being an action of the entity.

10. The method of claim 1, wherein the interaction between two entities comprises a trading phase in which each entity decides whether to comply with the promised outcome of the interaction or disregard the promised outcome resulting in the effective outcome of the interaction.

11. The method of claim 1, wherein the interaction between two entities comprises an evaluating phase in which each entity evaluates a utility of the interaction as to whether the result of the effective outcome is better than the promised outcome, worse than the promised outcome or corresponds to the promised outcome.

12. The method of claim 1, wherein said calculating is performed by a computer program.

13. A method for classifying interacting agents into cluster classes, comprising:
undergoing an interaction between two agents through
a negotiation phase in which the two agents agree on a promised outcome of the interaction, where the promised outcome involves an action of the agents;
a trading phase in which each agent decides whether to comply with the promised outcome of the interaction or disregard the promised outcome resulting in the effective outcome of the interaction; and
an evaluation phase in which each agent evaluates a utility of the interaction as to whether the result of the effective outcome is better than the promised outcome, worse than the promised outcome or corresponds to the promised outcome; and
calculating a conditional probability distribution of a classification of an agent to a cluster class using a model for infinite relational trust and depending on a plurality of attributes assigned to the agent and the interactions, the conditional probability distribution being generated by a prior on cluster assignment based on a Dirichlet distribution in which sampling is induced by a Chinese Restaurant process.

14. The method of claim 13,
further comprising classifying the interactions in interaction classes, and
wherein the model for infinite relational trust is employed for calculating the conditional probability distribution of a classification of an interaction to a cluster class depending on a plurality of attributes assigned to the agents and the interactions.

15. The method of claim 13, wherein the negotiation phase determines, based on the cluster assignment of the agents and interactions for at least one predetermined agent, a respective promised outcome.

16. A method for determining a reliability of interactions between interacting agents, an interaction being a relation between a trusting agent and a trustee agent based on a promised outcome resulting and an effective outcome under external conditions, comprising:
assigning at least one condition attribute to each condition;
assigning at least one agent attribute to each agent;
assigning a plurality of relationship attributes to the relation;
classifying each agent into an agent cluster group and each external condition into a condition cluster group based on said assigning of the at least one condition attribute, the at least one agent attribute and the relationship attributes, by calculating a conditional probability of a classification of an agent or condition into at least one of an agent cluster group and a condition cluster group using a relational model having the conditional probabilities as hidden variables; and
calculating a utility measure for achieving the promised outcome based on the classification of each agent and each condition to a corresponding agent cluster group and a corresponding condition cluster group, respectively, the utility measure indicating a probability for achieving at least the promised outcome as the effective outcome.

17. The method of claim 16, wherein said classifying of each agent and/or each external condition to a cluster is done depending on a Chinese Restaurant Process.

18. The method of claim 16, further comprising making a decision on the promised outcome for at least one agent based on the promised outcome of a respective interacting party.

19. The method of claim 16, wherein the agent is a company, brand, authority, user, or client device.

20. The method of claim 16, wherein the promised outcome is a price for merchandise, a set of services, or a delivery time.

21. A computer readable medium encoded with a computer program that when executed by a computer determines a reliability of interactions between interacting agents, an interaction being a relation between a trusting agent and a trustee agent based on a promised outcome resulting and an effective outcome under external conditions in a method comprising:
assigning at least one condition attribute to each condition;
assigning at least one agent attribute to each agent;
assigning a plurality of relationship attributes to the relation;
classifying each agent into an agent cluster group and each external condition into a condition cluster group based on said assigning of the at least one condition attribute, the at least one agent attribute and the relationship attributes, by calculating a conditional probability of a classification of an agent or condition into at least one of an agent cluster group and a condition cluster group using a relational model having the conditional probabilities as hidden variables; and
calculating a utility measure for achieving the promised outcome based on the classification of each agent and each condition to a corresponding agent cluster group and a corresponding condition cluster group, respectively, the utility measure indicating a probability for achieving at least the promised outcome as the effective outcome.

22. The computer readable medium of claim 21, wherein the computer readable medium comprises at least one of the group of a floppy disk, a hard drive, a CD-ROM, a DVD, a downloadable file, or a USB storage stick.
